(19) United States
(12) Patent Application Publication
(10) Pub. No.: US 2004/0183833 A1
(43) Pub. Date: Sep. 23, 2004

(54) Keyboard error reduction method and apparatus

(76) Inventor: Yong Tong Chua, Singapore (SG)

Correspondence Address: MOTOROLA INC, 600 NORTH US HIGHWAY 45, ROOM AS437, LIBERTYVILLE, IL, 60048-5343, US

(21) Appl. No.: 10/391,867

(22) Filed: Mar. 19, 2003

(51) Int. Cl. G09G 5/00

(52) U.S. Cl. 345/773

(57) ABSTRACT

In a mobile telephone (10) with a virtual keyboard and a touch screen (12), with individual virtual keys (22) having their own representative positions. During a selection operation to select a key (22), where the touch screen is touched becomes the selected position. The distance between the selected position and adjacent representative positions is used to decide a first set of candidate keys. These candidate keys are then used to provide a set of potential words that would result from the input of any one of those keys. A list of candidate words is then produced and displayed on a display area (26) based on the frequency of use of the words in the set of potential words and the distances between the selected position and the representative position of the keys (22). Once a key (22) is confirmed as having been selected, the offset between the selected position and the representative position of that key is used to re-calibrate that representative position.

FIG. 1 accompanies this abstract.

### FIELD OF THE INVENTION

This invention relates to the selection of items displayed on a screen, for example virtual keyboard keys. The invention is particularly useful for, but not necessarily limited to keyboard keys on a touch screen and is aimed at helping reduce errors in the selection of keys.

### BACKGROUND ART

A frequently used interface between man and machine is a display screen. Increasingly, such screens are not just used for one way communication, that is to display data to the user, but also as means for the user to input data to the relevant apparatus, for example by way of a touch screen or the use of a mouse (or other cursor-orientated selections) or such like.

One of the main growth areas in screen devices is in small portable devices, such as mobile telephones, personal digital assistants (PDA), global positioning system (GPS) navigators and the like. These adopt various methods for entering symbols or data into them, for instance buttons, voice recognition, hand writing recognition virtual buttons (such as virtual keyboard), etc. In the last case various buttons appear on the screen and touching the screen at a point corresponding to one of those buttons causes the device to react as if the corresponding button itself had been touched. The construction of touch screens is well known in the art and touch detection can be way of many well known systems, such as capacitive or inductive sensing, contact switches etc.

Whilst touch screens and other screen input devices are very useful, they can suffer from the problem of parallax error. This is where the point the user thinks an image appears on the screen is actually displaced slightly, due to being viewed at an angle. This is particularly a problem in touch screens where the selected position, at the point of contact on the screen, is removed from the image of a target button by the thickness of the sensor screen and display glass. Unless the viewer is looking along a line substantially perpendicular to the plane of the screen from directly in front of the target button, the point on the front of the sensor screen where, he thinks he sees the target, is not exactly where the sensor corresponds to that target button. The offset between the actual position of the button and where the user sees the button as being, depends upon the angle between the viewer and the plane of the screen.

This problem can be exacerbated with mobile, hand held devices where a user is using one hand to select targets on a touch screen held in the other hand. There, the most natural and comfortable position may involve holding the device at an angle to the viewer's eyes and slightly towards the other hand. This ensures that parallax remains a problem. Further, screens on hand held devices tend to be quite small. The virtual buttons on them are clearly smaller than the screen and are usually very much smaller. Where many buttons appear, for instance in a virtual keyboard, the size is such that parallax, combined with inaccurate aim, can very easily lead to a significant number of errors in typing.

### SUMMARY OF THE INVENTION

In this specification, including the claims, the terms ‘comprises’, ‘comprising’ or similar terms are intended to mean a non-exclusive inclusion, such that a method or apparatus that comprises a list of elements does not include those elements solely, but may well include other elements not listed.

According to one aspect of the invention, there is provided a method for use in deciding a selectable portion that is selected during a selection operation from amongst a first plurality of selectable portions of an image displayed on a screen. A selection operation indicates a selected position in the image. Each of the first plurality of selectable portions has a representative position within the image. The method includes receiving input data identifying the selected position, indicated during the selection operation, and deciding on at least one candidate for the selected selectable portion, using the position of the selected position relative to the representative positions of a second plurality of the selectable portions.

According to another aspect of the invention, there is provided a method for use in displaying a plurality of selectable portions in an image displayed on a screen. Individual selectable portions are selected during selection operations where a selection operation indicates a selected position on the image. Each of the plurality of selectable portions has a representative position on the image. The method includes determining a selectable portion selected through a selection operation, determining an offset distance between the selected position and the representative position of the selected selectable portion and repositioning the representative position of the selected selectable portion using at least the determined offset distance.

According to again another aspect of the invention, there is provided a driver circuit for use in deciding a selectable portion that is selected during a selection operation from amongst a first plurality of selectable portions of an image displayed on a screen. The selection operation indicates a selected position in the image. Each of the first plurality of selectable portions has a representative position in the image. The circuit includes a memory for storing the representative positions of the selectable portions, an input for receiving a selected position from a selection operation and a microprocessor for deciding on one or more candidates for the selectable portion being selected through the selection operation, using the position of the received selected position relative to the representative positions of a second plurality of the selectable portions, stored in the memory.

### BRIEF DESCRIPTION OF THE DRAWING

In order that the invention may readily be understood and put into practical effect, reference will now be made to a preferred exemplary embodiment, as illustrated with reference to the accompanying drawings, in which:

FIG. 1 is an illustration of a mobile telephone of an exemplary embodiment;

FIG. 2 is a schematic view of a touch screen circuit of an exemplary embodiment;

FIG. 3 is a close up of an area of a display of an exemplary embodiment;

FIG. 4 is a flow chart according to the operation of an exemplary embodiment; and

FIG. 5 is a flow chart relating to sub-steps of one of the steps of the flow chart of FIG. 4.

### DETAILED DESCRIPTION OF THE PREFERRED EMBODIMENT OF THE INVENTION

In the drawings, like numerals on different figures are used to indicate like elements throughout.

In brief, in a mobile telephone with a virtual keyboard and a touch screen, individual virtual keys have their own representative positions. During a selection operation to select a key, where the touch screen is touched becomes the selected position. The distance between the selected position and adjacent representative positions is used to decide a first set of candidate keys. These candidate keys are then used to provide a set of potential words that would result from the input of any one of those keys. A list of candidate words is then produced based on the frequency of use of the words in the set of potential words and the distances between the selected position and the representative position of the keys. Once a key is confirmed as having been selected, the offset between the selected position and the representative position of that key is used to re-calibrate that representative position.

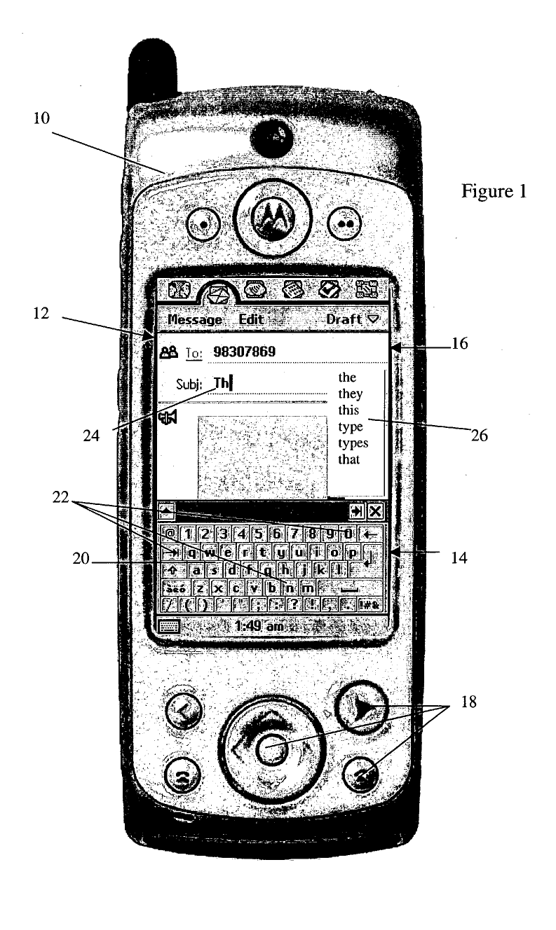

With reference to FIG. 1 there is illustrated a mobile telephone 10, embodying the invention. The telephone 10, as shown in this embodiment, has a touch screen 12, with an image spilt between a virtual keyboard area 14 and a message area 16. However, as will be apparent to a person skilled in the art, the area and position of the virtual keyboard can be selected a user. Also, Various control buttons 18 exist on the body of the telephone 10.

A virtual keyboard 20 is displayed in the image in the virtual keyboard area 14. The virtual keyboard 20 is made up of a number of individual selectable portions in the form of virtual keys 22, each of which has its own display area. There are separate keys 22 for every letter of the alphabet (typically in QWERTY arrangement) and for numbers 0-9. There are also keys 22 for punctuation marks, some accented letters, formatting keys, etc. For the purposes of this description, the term “symbol” covers the output from any key of the keyboard at least, whether it is a letter, number, punctuation mark or even just a space.

In a selection operation, by touching one of the virtual keys 22 of the virtual keyboard 20, the symbol on that key is selected to appear as the next symbol in a message line 24 in the message area 16. A stylus (not shown) is ideally used to select individual virtual keys 22 as it allows greater accuracy of touch or contact on the touch screen 12 than a finger.

The mobile telephone 10 includes predictive word input technology to help anticipate what the user is trying to input, with reference to a dictionary database. The predictive word input technology supplies a list of words to a list display area 26, which list is displayed in the message area 16, the list containing word choices to offer the user, so that he does not have to type the complete word. The user touches one of the words in the list display area 26 and the selected word then appears in the message line 24.

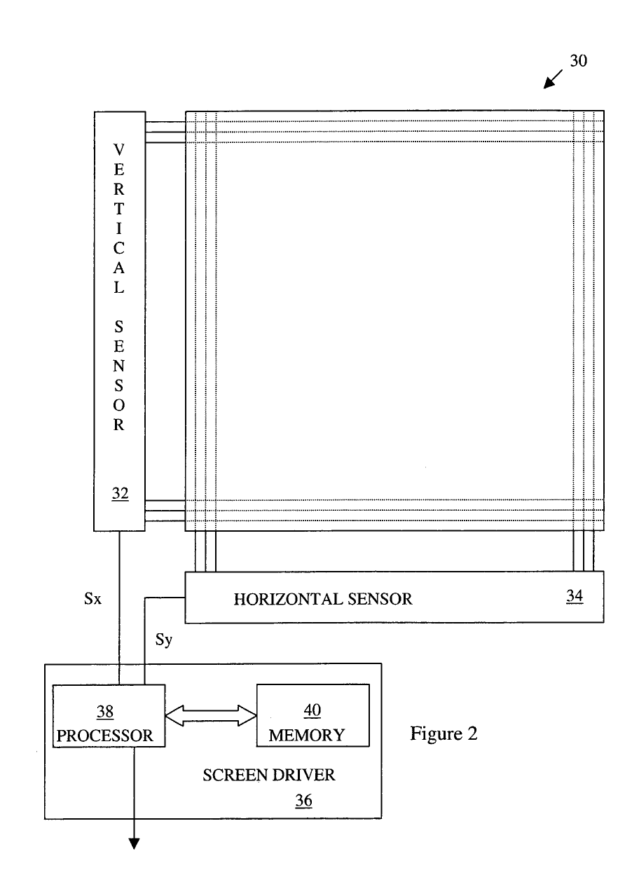

FIG. 2 is a schematic view of the touch screen circuit 30. Horizontal and vertical sensors 32, 34 are arranged to detect the point of contact, the selected position, of a touch on the touch screen 12. This information is supplied as signals Sx, Sy indicative of X and Y co-ordinates to a screen driver circuit 36 to interpret and to react accordingly. For instance if the driver circuit 36 interprets a touch as the selection of a letter, that letter appears in the message line 24 at the appropriate position or a list of words 26 appears for the user to select from. The screen driver circuit 36 has a processor 38 and a memory 40 containing, inter alia: the dictionary database, the current contents of the message line 24 and the X and Y positions of the keys 22 of the virtual keyboard 20. The information in the memory 40 on the positions of the keys 22 includes their representative positions, which is a single X, Y co-ordinate point associated with each key 22, as well as details of their display areas, that is where they extend in the display.

In this embodiment, touching a key 22 on the virtual keyboard 20 is not simply taken as a selection of that key. There may have been a mistake owing to parallax error and/or inaccurate aim. Instead, the driver circuit 36 uses the selected position relative to the representative positions of the keys to determine possible candidates (candidate keys) for the desired symbol. It also uses the offset between the selected position and the representative positions of the candidate keys and predictive word input technology to derive a list of candidate words. The word choices made available are taken from those that exist in the database dictionary, based upon the letters that have already been input in the current word string and how frequently the potential words are used. This is displayed and the user selects one of them if and as desired.

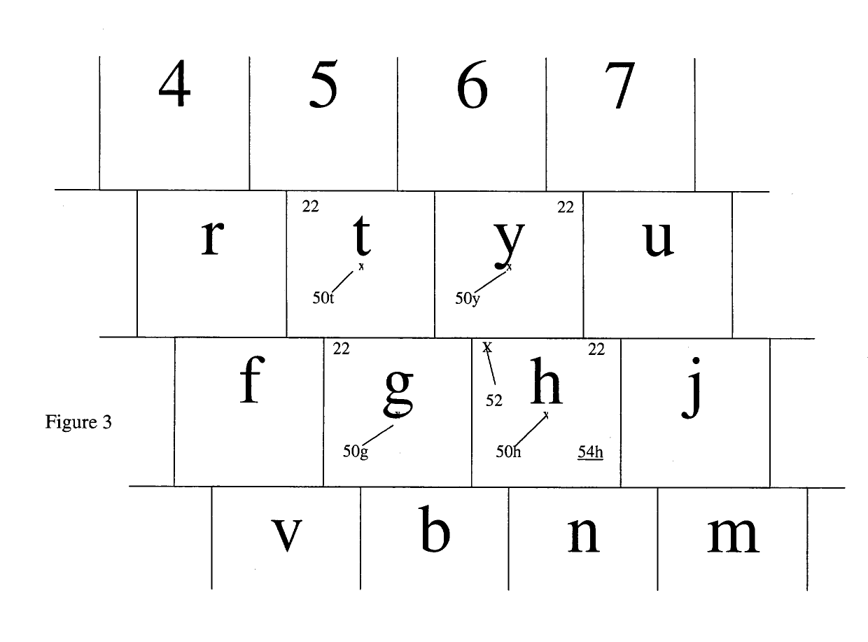

FIG. 3 is a close up of an area of the virtual keyboard 20. This area is roughly centred on the letter keys for “t”, “y”, “g” and “h”, each with its own representative position 50t, 50y, 50g, 50h. Assuming the user touches the screen 12 at the point 52, marked with an X, he may, indeed, have wanted to select the letter “h”, as the selected position 52 falls within the display area 54h for that letter. On the other hand, he may have been aiming at the “t”, “y” or “g” key and missed. After all, the selected position 52 is only just on the “h” key and, due to the staggered alignment of the rows of keys, is actually closer to the centre of the “y” key than to the centre of the “h” key. It is also not much further away from the centres of the “t” and “g” keys.

In brief, operation of the keyboard proceeds as follows. When a touch is detected at the selected position 52, the horizontal and vertical sensors 32, 34 pass the selected position 52 by way of signals Sx, Sy to the driver circuit 36. The processor 38 makes decisions and causes the display to be updated with a new symbol and a list of other candidate symbols or a list of candidate words. If a candidate symbol or word is chosen by the user or a preceding displayed symbol or string of symbols is in some other way approved (e.g. by the input of a space or line return), the processor 38 then re-calibrates certain representative positions in the memory 40.

The processor 38 may be a microprocessor or other circuit that is wired to operate according to the described operation. However, it is more likely and will become even more so that it will be embodied in software stored in non-volatile memory. Thus, in that the invention covers apparatus operable to perform certain processes, it includes that apparatus whether embodied by a hardwired circuit or embodied by a processor running software that can perform those processes.

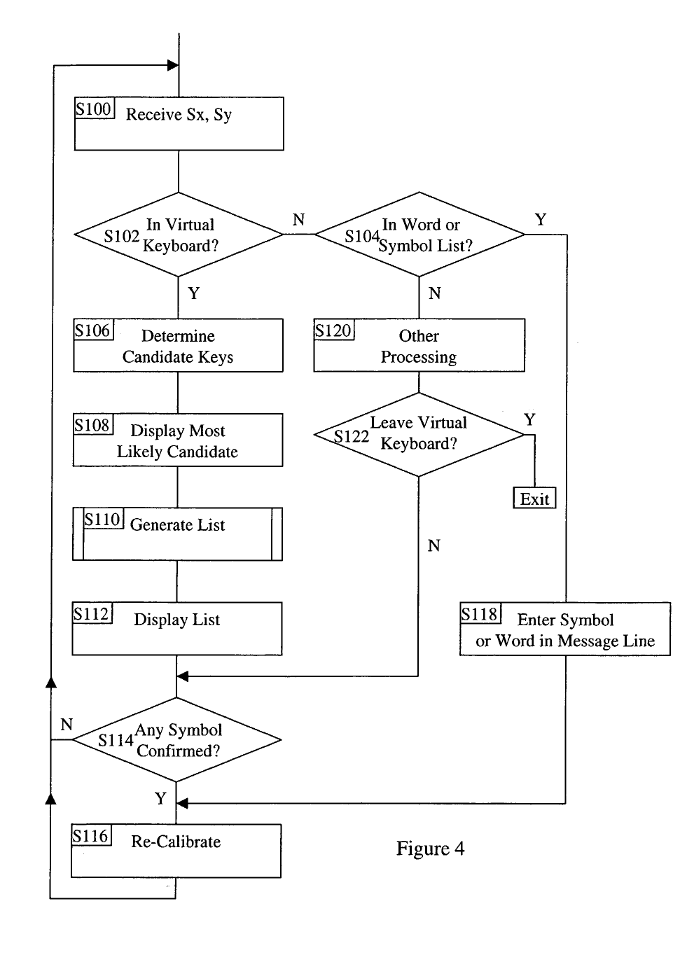

The operation of the processor 38 in this exemplary embodiment is described in more detail with reference to FIG. 4, which is a flow chart for this aspect of the invention. On receiving signals Sx, Sy (input data) in step S100, the processor 38 first determines in step S102 if they correspond to a position in the virtual keyboard 20. If they do not, then the process proceeds to step S104, which decides if the touch corresponded to a position in the list display area 26. If they do correspond to a position in the virtual keyboard 20 the processor 38 decides or determines in step S106 appropriate candidate keys for what the user intended. This determination is based on calculations of the distances from the selected position 52 to the representative positions 50t, 50y, 50g, 50h of the adjacent keys 22. Initially at least, as is shown in FIG. 3, the representative position 50 of a key 22 is at the centre of that key, but that may be modified as is discussed later (see Step S116).

The processor does not work out the distance from the selected position to the representative position for every possible key. It ignores those that are more than a predetermined distance away, which in this embodiment is the distance equal to the distance between the centres of two adjacent keys in the same row (e.g. from the centre of the “t” key to the centre of the “y” key). This leads to the selection of the letter “t”, “y”, “g” and “h” keys as candidates.

Another possibility is for the predetermined distance to be based on the distance between two adjacent keys in different rows (e.g. from the centre of the “y” key to the centre of the “g” key or from the centre of the “y” key to the centre of the “h” key). Many other possibilities exist. The distance that is used depends upon the sensitivity that the designer (or user) desires.

An alternative approach to selecting the candidate keys for the key that is pressed is to select the key in which the selected position falls, to work out the two closest sides of that key to the selected position and then to include those other keys that are in contact with any part of those two sides. Alternatively again, each key 22 can be divided into quarters and the candidates are chosen as the key in which the selected position falls and those keys adjacent to the key quarter in which the selected position falls. In these cases, the selected position 52 in FIG. 3 would only lead to the letter “y”, “g” and “h” keys as candidates.

In step S108 the most likely symbol of the candidate symbols is displayed in the relevant position in the message line 24. The most likely symbol is deemed to be the symbol from the key 22 in whose display area the selected position falls. Thus with the example shown in FIG. 3, the letter “h” would be displayed in the message line 24.

Alternatively, the processor would display the symbol from the key 22 whose representative position is closest to the selected position 52, in the current position in the message line 24. In the example shown in FIG. 3, although the selected position 52 is in the display area 54h of the “h” key, it is closer to the representative position 50y of the “y” key than to the representative position 50h of the “h” key. Thus the letter “y” would be displayed, and not the letter “h” in the message line 24.

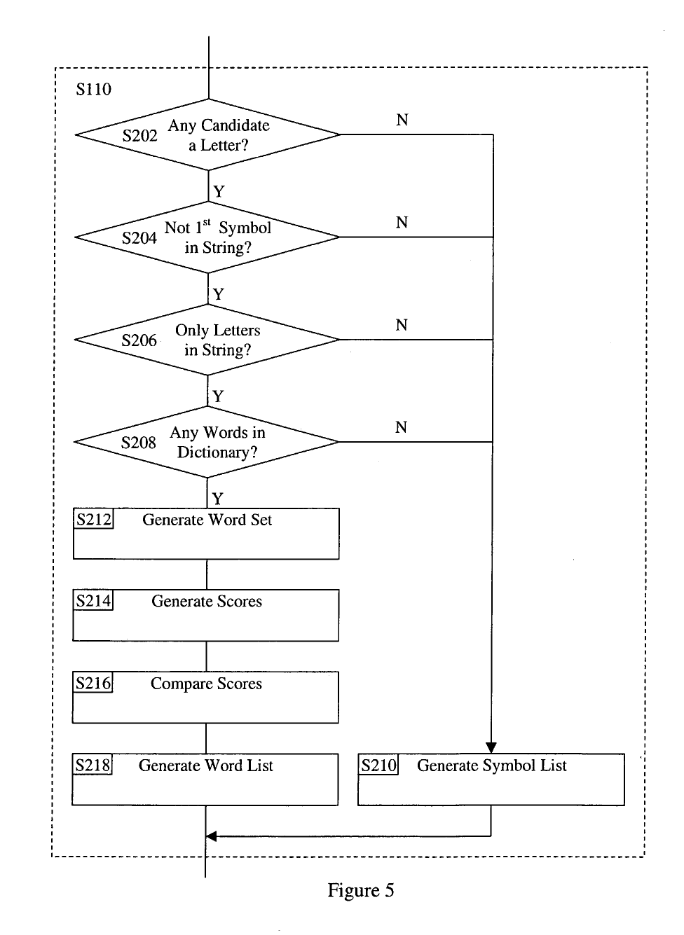

In step S110 the processor decides upon a list of candidates, either as alternatives to the symbol displayed in step S108 or as a complete word to replace the current string in message line 24. The sub-steps for this process are described later with reference to FIG. 5.

The following step S112 displays the list generated in step S110 in list display area 26. The process next passes through a decision step S114, where it decides if the preceding input has confirmed any keys, for example if an input symbol has been followed by a space, which has been followed by some other input, which means that the user intended the space and therefore intended what preceded the space. If confirmation has occurred, the next step is S116, where the representative positions of the keys representing the confirmed inputs, may be recalibrated. The process then reverts to step S100, as it also does if the answer to the question of step S114 is negative. Step S100 awaits a new user input. Typically this would be by way of a selection from an item in the displayed list, in which case the selected letter or word would appear in the message line 24, or this may be by way of a new input via the virtual keyboard, in which case the previously assumed symbol put in the message line 24 in step S108 remains there and the above process repeats itself. Alternatively, the user may be selecting some other instruction.

If step S104 determines that the current selected position 52 is within the list display area 26, the processor enters that selected word or symbol in the message line in step S118. The process then goes straight to step S116 for re-calibration of key representative positions. If step S104 determines that the current selected position 52 is not within the list display area 26, the next step is step S120, in which whatever other processing is necessary is carried out. Step S122 then determines if the process is to leave the virtual keyboard. If it is not leaving the virtual keyboard, the process reverts to step S114 to check if any symbol has been confirmed.

FIG. 5 shows the sub-steps for step S110 for generating a list. Firstly in step S202, the processor decides if any of the current candidate symbols is a letter. If at least one of them is a letter, then in step S204 the processor decides if the current input is not the first symbol in the current symbol string, i.e. whether it is the second or a later one. If it is not the first symbol in the string, then in step S206 the processor decides if the preceding symbols in the string are all letters. If they all are, then in step S208, the processor decides if any of the current candidate symbols could, if placed in the current letter string, lead to a word in the dictionary database in the memory 40.

If the answer to the decision in any of steps S202 to S208 is “No”, then the process proceeds to step S210, where a symbol list is generated just containing the symbols for the remaining candidate keys not displayed in the message line by step S108. These other symbols are placed in the list in the order of proximity of the selected position 52 to the representative positions for their corresponding selected candidate keys 22. Thus with the example shown in FIG. 3, when the letter “h” is displayed in the message line 24, the list would contain the letters “y”, “g” and “t”, in that order.

If the answer to the decision in every one of steps S202 to S208 is “Yes”, then the process proceeds to step S210, where a set of words is generated using the dictionary database. The set contains the current letter string in the message line with each candidate symbol at the end of it (except for the combination that is already displayed in step S108) and every possible word allowed by the insertion of each candidate symbol in the current letter string. In step S212 a weighting process is used to give scores to each possible member of the set. These scores are compared with each other in step S214 and a list of scoring members is generated in score order in step S216. In one embodiment, the list of scoring members will be a list of six alphanumeric characters that is typically the top six scoring members. However, the number in this list can vary and usually depends on the display area and font size.

In more detail, the weighting process in step S212, mentioned above, awards a score W_{final} to each member of the set according to the following formula:

W_{final}=a*W_{freq}+b*W_{distance} (1)

where W_{freq} is a score awarded to a word based upon the likelihood of that word or combination, which is usually attendant on its frequency of use, and W_{distance} is a score which is the inverse of the distance from the selected position 52 to the representative position for the key that would be required for that word or combination to be the correct one. In formula (1), “a” and “b” are precept constants which are set to give a good balance between selection based on word frequency and selection based on the distance of the selected position to the representative position of a key.

In variant embodiments, there can be a learning programme to vary these constants “a” and “b” so that the more accurate the user's selection history tends to be, the higher the value “b” becomes relative to the value “a” and the greater the weighting given to the distance score over the likelihood score.

Every word in the dictionary database is given a likelihood score, W_{freq} on a scale of 1-10, which is also maintained in the memory 40. The dictionary database may not necessarily include every word in a particular language and size of the dictionary database depends the memory space allocated by the memory 40. The most frequently used words such as “the” have a score of 10 , whilst less frequently used words like “theomachy” have a score of 1, with most words in between. For the purposes of formula (1), combinations that do not appear in the dictionary database are treated as having a likelihood score, W_{freq} of 0.

The word scores are preset in the factory but are automatically modified through use, so that words used more frequently by the user get a higher W_{freq} score and words used less frequently get a lower W_{freq} score. New words can also be added through a learning process. The predictive word input technology can usefully automatically track the frequency of word use. For instance: if a non-dictionary word is selected even once, it is added to the dictionary and every five times a word is used, it gains a higher score. In this example, there may be no more than a predetermined number of words with any one W_{freq} score; when one word moves up or down a score, taking the number of words with that score over the maximum, the least frequently used word from that score moves down. Individual user's habits can also be learned. Thus, if more than one user uses any one device, then the different users can be identified and their habits learned separately.

In further variants, the predictive word input technology can also take advantage of grammar checking technology as an extra factor in deciding scores.

Normally the dictionary only contains words containing letters. However, alternative embodiments provide a dictionary database with symbol strings containing symbols other than letters, and/or the ability to learn such strings (for instance telephone numbers). In such embodiments, various steps, such as steps S202 and S206 are adjusted to allow through non-letter symbols.

Step S116, mentioned above, relates to re-calibration of representative positions of the keys. This aspect is based on the fact that people tend not to be random in where they touch a screen to select a particular key. They tend to hold the device in a similar position throughout each use and from one use to another, with the same parallax error in each case. Thus they are likely to touch the screen at roughly the same position, each time when they want a particular key, even though that position may not be directly above the desired key.

As is mentioned above, initially the representative position of a key is at its centre. Whilst that is where it starts, it is not fixed there and can be re-calibrated based on use. More particularly, the system learns from the confirmation of previous key selections and moves the representative position of each key towards where the user tends to touch the screen when selecting that key. Thus, during symbol and word selection, the X and Y offset from the key centre, for each key that is input, is collected and, once a candidate word is selected or a symbol confirmed (e.g. by way of a return or space input), those offsets are used to calculate new positions for the respective representative positions or their respective keys to recalibrate the touch panel.

For each input symbol, there is an X offset (Xoff-cent) between the selected position 52 and the centre of the symbol key and a Y offset (Yoff-cent) between the selected position 52 and the centre of the symbol key. During the re-calibration process in step S116, those offsets are used to calculate a new representative position for the respective key. This is calculated based on an average.

More particularly, the new representative positions for each key, Xnew and Ynew, in terms of the X and Y offset from the centre of each key are determined by the following formulae:

Xnew=(Xoff-cent+ΣXoff-cent-old)/n (2)

Ynew=(Yoff-cent+ΣYoff-cent-old)/n (3)

where “ΣXoff-cent-old” is the sum of all previous “Xoff-cent” used in recalculating the representative position for this key, “ΣYoff-cent-old” is the sum of all previous “Yoff-cent” used in recalculating the representative position for this key, and “n” is the number of times the representative position for this key has been recalculated, including the current time.

So that initial inputs do not skew the results, “ΣXoff-cent-old” and “Yoff-cent-old” are originally set at “0” and “n” is precept to a large figure such as 100. This therefore gives weight given to the existing representative position.

This calculation means that the original setting will always be a factor in Xnew and Ynew. This can avoided, for instance by replacing “ΣXoff-cent-old” and “ΣYoff-cent-old” with just a certain number of the latest preceding “Xoff-cent” and “Yoff-cent”, for instance the previous 99 of each and keeping “n” at 100. This method will lead to consistent representative positions from consistent selected positions quite quickly, but is heavier on memory requirements.

Another alternative would be to replace formulae (2) and (3) with:

Xnew=(Xoff-cent+[m−1]Xold)/m (2a)

Ynew=(Yoff-cent+[m−1]Yold)/m (3a)

where “Xold” and “Yold” are the current X and Y values of the representative positions and “m” is a constant, selected to give sufficient weight to the existing position, so that extreme selected positions are ironed out, for instance “m” may be 100.

These above approaches rely on calculating an offset from the centre of each key, which means calculating those offsets, in addition to knowing the distance from the selected position to the actual representative position (used in step S106, described above). It is, however, possible to calculate new positions based only on the previous representative position or positions, rather than the centre of a key. For instance, if the old position is considered 99 times more important than the new one, the new representative position would be moved 1/100 of the way from the previous representative position towards the selected position that led to the selection of that confirmed symbol. It is also possible to calculate new representative positions based on averages of the absolute X and Y positions on the screen, rather than relating them to previous representative positions or the centres of the keys.

Various other possibilities for deciding upon the new calibrated position can easily be used.

Once the new representative position for a key has been calculated, it is stored in the memory 40 for use in the next run through of the process. Once the representative positions of all relevant keys have been adjusted in step S116, the process reverts to step S100.

Whilst the above embodiment has re-calibration only for the confirmed symbols, it can operate for every symbol once that is displayed in the message line from a virtual keyboard selection. However, this is more likely to include erroneous selections where the user simply aimed badly and then had to correct.

A re-calibration system as above without any check on it can be abused, theoretically to the extent that after sufficient use a representative position could bear no relationship to the position of the keys in the virtual keyboard. It is therefore useful to provide a reset function to allow complete resetting of the representative positions. Alternatively or additionally, no representative position may be allowed to wander too far from its original position, for instance in some embodiments outside the display area of the respective key, or in other embodiments farther then halfway towards any of the edges of the key.

### EXAMPLE

An example of the above-described process in selecting a word is now provided. In this example, the user wishes to input the word “this”. For this example, the initial letter “t” has already been displayed in the message line, as a first symbol of the symbol string. This was the result of step S108 of the previous run through of the process of FIG. 4. Now the user touches the screen again to put in the letter “h” and touches the screen, at the selected position 52 in FIG. 3. As the preceding input has not yet been confirmed, the previous run through of this process went from step S114 to step S100, without any re-calibration.

The Sx, Sy values for the selected position 52 are received by the processor in step S100. These are found to correspond to a position in the virtual keyboard in step S102. Thus the user has not selected an item from a list or some other instruction and the previously displayed list can disappear. Candidate keys for the new input need to be determined in step S106, and this involves determining the distances to the representative positions of keys.

Each of the letter keys is a square of 3 mm by 3 mm, with the stagger between rows leading to a key in one row abutting 0.75 mm of one key in the row below it and 2.25 mm of another key in the row below it. In FIG. 3 the “t” key abuts 0.75 mm of the “f” key and 2.25 mm of the “g” key and the “y” key abuts 0.75 mm of the “g” key and 2.25 mm of the “h” key. In this example, the selected position 52 falls within the display area of the “h” key and is 0.3 mm along from the shared boundary of the “g” and “h” keys and 0.15 mm down from the shared boundary of the “y” and “h” keys. By Pythagoras, the offset distance from the selected position 52 to the representative position of each of the “t”, “y”, “g” and “h” keys is:

key t=3.0 mm ( [symbol] W_{distance}=0.33 for the purpose of formula 1)

key y=1.7 mm ( [symbol] W_{distance}=0.58 for the purpose of formula 1)

key g=2.3 mm ( [symbol] W_{distance}=0.44 for the purpose of formula 1)

key h=1.8 mm ( [symbol] W_{distance}=0.55 for the purpose of formula 1)

Although the distance to the representative position of the “y” key is the smallest offset, as the selected position 52 falls within the display area 54h of the “h” key, step S108 still selects and displays the letter “h” in the current position of the message line.

As at least one candidate is a letter, the next step S202 leads on to step S204. This determines that the symbol currently being input is not the first symbol in the string (as “t” is already there), after which step S206 determines that all the previous symbols in the string have been letter symbols (in this case the only previous symbol was the letter “t”). In step S208 the processor looks at the dictionary database to see if any words are possible. Whilst there are no such words beginning “tt” or “tg”, there are some beginning “th” or “ty”. Thus the process passes on to step S210, where a set of words is generated for each candidate. The sets generated in this example are:

For “t”

“tt” -(W_{freq}=0)

For “y”

“type” -(W_{freq}=8)

“types” -(W_{freq}=8)

“typed” -(W_{freq}=7)

“typical” -(W_{freq}=6)

“typically” -(W_{freq}=5)

“typing” -(W_{freq}=5)

For “g”

“tg” -(W_{freq}=0)

For “h”

“the” -(W_{freq}=10)

“they” -(W_{freq}=9)

“this” -(W_{freq}=9)

“that” -(W_{freq}=8)

“there” -(W_{freq}=8)

“these” -(W_{freq}=8)

The W_{freq} indicated is the relevant W_{freq} from the dictionary. The default value is 0, where a string does not appear there. Thus whilst “tt” and “tg” do not appear in the dictionary, they are still deemed possible and appear in this list with W_{freq} of 0. For “ty” and “th”, there are many more examples than just the six illustrated. However, there is no point in obtaining those for scoring, since no more than six possibilities will appear in the final list. The top six scoring W_{freq} words for any possibility are chosen. Where two words have the same W_{freq}, they are chosen and listed in alphabetical order.

Using formula (1) [W_{final}=a*W_{freq}+b*W_{distance}], with the constants “a” and “b” given the values 1 and 15, respectively, the total scores given to the candidate words/strings indicated above are calculated in step S212 as:

“tt” -(W_{final}=4.9)

“type” -(W_{final}=16.8)

“types” -(W_{final}=16.8)

“typed” -(W_{final}=15.8)

“typical” -(W_{final}=14.8)

“typically” -(W_{final}=13.8)

“typing” -(W_{final}=13.8)

“tg” -(W_{final}=6.7)

“the” -(W_{final}=18.3)

“they” -(W_{final}=17.3)

“this” -(W_{final}=17.3)

“that” -(W_{final}=16.3)

“there” -(W_{final}=1 6.3)

“these” -(W_{final}=16.3)

The scores are compared in step S214 and the list generated in step S216, containing the top six candidate strings in score order, with alphabetical order being secondary, is:

“the”, ”they”, “this”, “type”, “types”, “that”.

This list of words is then displayed in the list display area 26 in step S112. Step S114 determines if any symbol has yet been confirmed. In this case, the initial “t” not yet been confirmed, as there is no space or some such following it. The second letter is also not confirmed as nothing has been selected from the list yet, so the negative answer takes the process back to step S100.

In order to continue inputting the word “that”, the user does not need to type in the letters “a” and “t”, he just needs to touch the word “that” in the list display area 26. The relevant position signals are provided in step S100 and step S102 determines that the new selected position 52 is not within the virtual keyboard. So it is succeeded by step S104, which determines that the new selected position 52 falls within the list display area 26. In the following step S18, the word “that” appears in the message line 24. Step S118 is followed by step S116 for the re-calibration operation.

Where a selection is made from a word list generated by step S216, the existing current symbol string (in this case “th”) is deleted and replaced in step S118 with the chosen word, in this example “that”. The deletion of the existing string, or at least the latest symbol placed there in the previous working of step S108, is useful to make sure that the correct word is displayed, since the current displayed symbol string (resulting from previous step S108) may not be consistent with the selected word from the word like (for example if “type” had been chosen, rather than “that”).

In this example, the word “that” is selected by the user. The re-calibration step S116 has two keys to re-calibrate, as only two letters “t” and “h” were selected (although the “a” and the second “t” are part of “that”, they were not selected keys or symbols as such). For the “h”, using the figures given above, the selected position is offset 1.2 mm left of the centre (which co-exists with the representative position in this example) and 1.35 mm above it. As this is the first time “h” has been reset, “ΣXoff-cent-old” and “ΣYoff-cent-old” are precept at 0, and “n” is precept at 100. Then using formulae (2) and (3) above:

Xnew=(−1.2+0)/100=−0.012

Ynew=(1.35+0)/100=0.014

Thus, the new representative position for “h” is 0.012 mm left of the centre of the “h” key and 0.014 mm above the centre of the “h”0 key. The representative position of the “t” key would be re-calculated in a similar manner based on the relevant selected position which led to its input.

On the other hand, had the user wanted to input a different word, such as “these”, which was not one of the displayed list, he would go straight to inputting another letter, without touching the list, and the process would go from step S102 to step S106 instead of to S104 and proceed in a similar manner as that which led to the display of the letter “h”, described above.

The above embodiment has each representative position calculated and stored separately. However, in another alternative, representative positions can all be moved together. This is based on the fact that if there is a parallax problem, it is likely to be the same for every key and therefore the offset in the selected position is likely to be the same or similar for every selected key. Thus all the offsets in the selected keys are averaged and used together in step S116 to generate the new position of every representative position.

The main embodiment described above includes the following features:

(i) candidate keys are selected based on proximity of their representative positions to the selected position;

(ii) candidate words are selected based on the proximity of the representative positions of relevant keys to the selected position and word likelihood; and

(iii) representative positions are repositioned based on the selected positions relative to the representative positions of the intended keys.

However, the present invention does not require that all of (i), (ii) and (iii) are present. For instance different aspects of the invention include any one or more of these:

1—(i) without (ii) or (iii) [for instance deciding on candidate keys based upon distance and putting the top candidate into the message line];

2—(ii) without (i) or (iii) [for instance deciding on the closest key and only generating a word list for that key];

3—(iii) without (i) or (ii) [for)instance deciding on the closest key and resetting the representative position for that key];

4—(i) and (ii) without (iii) [for instance deciding on candidate keys based upon distance, putting the top candidate into the message line and generating a word list as described];

5—(i) and (iii) without (ii) [for instance deciding on candidate keys based upon distance, putting the top candidate into the message line and resetting the representative position for that key];

6—(ii) and (iii) without (i) [for instance deciding on the closest key, only generating a word list for that key top and resetting the representative position for that key]; or

7—(i), (ii) and (iii) [as described].

These combinations are not just possible for the main embodiments of (i), (ii) and (iii), but also for the various alternatives mentioned and others.

In the main embodiment, the bigger keys, such as the space and return keys are not included, in that if the selected position falls within the display area of any such key, that key is always taken to have been selected. For this purpose, such keys would be taken not to be within the virtual keyboard for the purposes of step S102.

In an alternative, the bigger keys in the virtual keypad are provided with several representative positions (although only one display area appears in the virtual keyboard). If a selection operation leads to a selected position near any one of those representative positions, then the particular key is operated. Splitting the larger keys, in effect, into several smaller keys each with its own representative position, allows the larger keys to be as much of a potential candidate as the smaller ones (although associated candidate words would be by way of an indication of a space, a line break or whatever else would be appropriate). It also allows their representative positions to be re-calibrated in the same way.

It is also or alternatively possible for the smaller keys (i.e. most of the keys) to have several representative positions, spaced apart. In this manner, if a selected position falls between the representative positions belonging to the same key, it can be decided that that key alone was intended.

The above described embodiments relate to a virtual keyboard and selection of keys thereon by a touch screen of a mobile telephone. It is clearly evident that the invention would apply to almost any situation where a touch screen is used, for instance in a PDA or even non-mobile environments. Additionally, this invention is also applicable to other systems where there are selectable portions on a screen, representing individual symbols, instructions or such like. It would be particularly useful where parallax is a problem (for instance selection by light beam on a light sensitive front screen or selection by cursor movement in a screen in front of the selection screen). It would also be useful in other systems where a user's selection may not be as accurate as it should, for instance even in a normal mouse selection environment.

Of course the arrangement of any keyboard is not limited to that shown. For example the letter and number keys can easily vary. Further, the alphabet does not need to be Roman but could be Greek, Cyrillic, Arabic or any other one or could be replaced with characters, such as Chinese, Japanese or others. Likewise the numbers symbols could be Arabic, Chinese or others.

The invention is not just limited to use with a keyboard. The functions provided, at least those relating to determining candidates for what was intended and for re-calibration, can be used with the selection of any button from a set of buttons or other selectable portions in an image.

The detailed description provides a preferred exemplary embodiment only and is not intended to limit the scope, applicability or configuration of the invention. Rather, the detailed description of the preferred exemplary embodiment provides those skilled in the art with an enabling description for implementing the preferred exemplary embodiment of the invention. It should be understood that various changes can be made in the function and arrangement of elements without departing from the spirit and scope of the invention as set forth in the appended claims.

We claim:

1. A method for use in deciding a selectable portion that is selected during a selection operation from amongst a first plurality of selectable portions of an image displayed on a screen, where the selection operation indicates a selected position in the image and each of said first plurality of selectable portions has a representative position within the image, the method comprising:
receiving input data identifying the selected position, indicated during the selection operation; and
deciding on at least one candidate for the selected selectable portion, using the position of the selected position relative to the representative positions of a second plurality of the selectable portions.

2. A method according to claim 1, wherein deciding on at least one candidate for the selected selectable portion comprises determining offset distances between the selected position and the representative positions of the second plurality of the selectable portions and using at least said distances.

3. A method according to claim 2, further comprising determining the second plurality of the selectable portions by selecting those selectable portions whose offset distances are smaller than a predetermined distance.

4. A method according to claim 2, wherein the selectable portions represent symbols, with successive selection operations selecting a succession of symbols and building up a symbol string of successive symbols; and
deciding on at least one candidate for the selected selectable portion comprises deciding on a list of candidate symbol strings, each including previously selected symbols and one of said plurality of candidates for the selected selectable portion, arranged in an order of likelihood.

5. A method according to claim 4, wherein deciding on the list of candidate symbol strings comprises allotting scores to individual symbol strings of a plurality of potential candidate symbol strings, based on at least the determined offset distances.

6. A method according to claim 5, wherein deciding on the list of candidate symbol strings further comprises allotting scores to the individual symbol strings of the plurality of potential candidate symbol strings, based on the likelihood of those strings.

7. A method according to claim 5, wherein the score, W_{final}, allotted to a candidate symbol string is defined by:
W_{final}=a*W_{freq}+b*W_{distance}
where W_{freq} is an amount determined according to the frequency of use of the symbol string and W_{distance} is an amount determined according to the determined distance for the candidate selectable portion in the candidate symbol string and “a” and “b” are constants.

8. A method according to claim 4, further comprising:
sending the list of candidate symbol strings for display;
detecting a confirmation operation, selecting one of the list of candidate symbol strings; and
sending the selected one of the list of candidate symbol strings for display.

9. A method according to claim 1, further comprising:
detecting a confirmation selection, confirming the or one of the candidates for the selected selectable portion as the selected selectable portion; and
repositioning the representative position for the selected selectable portion.

10. A method according to claim 8, further comprising repositioning the representative positions for the selectable portions represented by the symbols in the selected one of the list of candidate symbol strings, and which were selected by the successive selection operations.

11. A method according to claim 10, further comprising calculating where to move the representative positions for the selectable portions whose representative positions are being repositioned, the calculation for where to move the representative position of a selectable portion being based on the offset distance of the selectable portion when it was selected and data relating to other selection operations.

12. A method according to claim 11, wherein the data relating to other selections comprises historical data relating to previous selection operations of at least that selectable portion.

13. A method for use in displaying a plurality of selectable portions in an image displayed on a screen, individual selectable portions being selected during selection operations where a selection operation indicates a selected position on the image, and each of said plurality of selectable portions having a representative position on the image, the method comprising:
determining a selectable portion selected through a selection operation;
determining an offset distance between the selected position and the representative position of the selected selectable portion; and
repositioning the representative position of the selected selectable portion using at least the determined offset distance.

14. A driver circuit for use in deciding a selectable portion that is selected during a selection operation from amongst a first plurality of selectable portions of an image displayed on a screen, where the selection operation indicates a selected position in the image and each of said first plurality of selectable portions has a representative position in the image, the circuit comprising:
a memory for storing the representative positions of the selectable portions
an input for receiving a selected position from a selection operation; and
a microprocessor for deciding on one or more candidates for the selectable portion being selected through the selection operation, using the position of the received selected position relative to the representative positions of a second plurality of the selectable portions, stored in the memory.

15. A driver circuit according to claim 14, wherein the microprocessor is operable to determine offset distances, being the distances between the selected position and the representative positions of the second plurality of the selectable portions and to decide on said one or more candidates for the selectable portion being selected using at least said offset distances.

16. A driver circuit according to claim 15, wherein the microprocessor is further operable to determine the second plurality of the selectable portions selecting those selectable portions whose offset distances are smaller than a predetermined distance.

17. A driver circuit according to claim 16, wherein the selectable portions represent symbols, with successive selection operations selecting a succession of symbols and building up a symbol string of successive symbols; and
the microprocessor is operable to decide on a list of candidate symbol strings, each including previously selected symbols and one of said plurality of candidates for the selected selectable portion, arranged in an order of likelihood.

18. A driver circuit according to claim 17, wherein, in deciding on the list of candidate symbol strings the microprocessor allots scores to individual symbol strings of a plurality of potential candidate symbol strings, based on at least the determined offset distances.

19. A driver circuit according to claim 18, wherein, in deciding on the list of candidate symbol strings the microprocessor allots scores to the individual symbol strings of the plurality of potential candidate symbol strings, based on the likelihood of those strings.

20. A driver circuit according to claim 18, wherein the score, W_{final}, allotted to a candidate symbol string is defined by:
W_{final}=a*W_{freq}+b*W_{distance}
where W_{freq} is an amount determined according to the frequency of use of the symbol string and W_{distance} is an amount determined according to the determined distance for the candidate selectable portion in the candidate symbol string and “a” and “b” are constants.

21. A driver circuit according to claim 17, further comprising:
an output for sending the list of candidate symbol strings for display; and wherein
the input is operable to receive a confirmation operation, selecting one of the list of candidate symbol strings; and
the microprocessor is operable to add the selected candidate symbol string as entered data.

22. A driver circuit according to claim 14, wherein the microprocessor is operable to:
detect a confirmation selection, confirming the or one of the candidates for the selectable portion being selected as the selected selectable portion; and
reposition the representative position of the selected selectable portion.

23. A driver circuit according to claim 21, wherein the microprocessor is operable to reposition the representative position for the selectable portions represented by the symbols in the selected one of the list of candidate symbol strings, and which were selected by the successive selection operations.

24. A driver circuit according to claim 23, wherein, when repositioning representative positions, the microprocessor calculates where to move a representative position based on the offset distance of the selectable portion when it was selected and data relating to other selection operations.

25. A driver circuit according to claim 24, wherein the data relating to other selections comprises historical data relating to previous selection operations of at least that selectable portion.
